(19) United States
(12) Patent Application Publication
(10) Pub. No.: US 2015/0105245 A1
(43) Pub. Date: Apr. 16, 2015

(54) Zero-PGM Catalyst with Oxygen Storage Capacity for TWC Systems

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTI, Ventura, CA (US)

(21) Appl. No.: 14/055,334

(22) Filed: Oct. 16, 2013

(51) Int. Cl. B01J 23/889

(52) U.S. Cl. CPC B01J 23/8892
USPC 502/324

(57) ABSTRACT

ZPGM-ZRE catalyst system substantially free from platinum group (PGM) and rare earth (RE) metals for TWC application is disclosed. Disclosed ZPGM-ZRE catalyst system may include pure alumina as washcoat and a Cu—Mn stoichiometric spinel with Nb₂O₅—ZrO₂ support oxide, as ZPGM-ZRE catalyst in overcoat. Disclosed ZPGM-ZRE catalyst systems are found to have high thermal stability, catalyst activity, and high oxygen storage capacity compared to commercial PGM catalyst system that includes Ce-based oxygen storage material (OSM).

### CROSS-REFERENCE TO RELATED APPLICATIONS

The present disclosure is related to U.S. patent application entitled “Thermally Stable Compositions of OSM free of Rare Earth Metals”, filed Oct. 16, 2013, the entirety of which is incorporated by reference as if fully set forth herein.

### BACKGROUND

1. Technical Field

The present disclosure relates generally to ZPGM catalyst systems with OSC property, and, more particularly, to thermal stability and activity of ZPGM TWC systems.

2. Background Information

Catalysts in catalytic converters have been used to decrease the pollution caused by exhaust from various sources, such as automobiles, utility plants, processing and manufacturing plants, airplanes, trains, all-terrain vehicles, boats, mining equipment, and other engine-equipped machines. Important pollutants in the exhaust gas of internal combustion engines may include carbon monoxide (CO), unburned hydrocarbons (HC), nitrogen oxides (NOx), and particulate matter (PM). Several oxidation and reduction reactions take place in the catalytic converter, which is capable of removing the major pollutants HC, CO and NOₓ simultaneously, therefore, it is called a three-way catalyst.

Catalytic converters are generally fabricated using at least some platinum group metals (PGM). With the ever stricter standards for acceptable emissions, the demand on PGM continues to increase due to their efficiency in removing pollutants from exhaust. However, this demand, along with other demands for PGM, places a strain on the supply of PGM, which in turn drives up the cost of PGM and therefore catalysts and catalytic converters.

Oxygen storage materials (OSM) are often included in automotive catalyst compositions to store oxygen under lean condition so oxygen can be released under rich condition. TWC catalysts are therefore characterized in one aspect with an oxygen storage capacity (OSC). As the TWC catalyst ages, however, its ability to store oxygen diminishes and the efficiency of the catalytic converter decreases.

Ceria (CeO₂) was the first material used as OSM in catalyst systems because of its effective oxygen storage capacity (OSC) properties. Subsequently, a CeO₂—ZrO₂ solid solution replaced ceria because of its improved OSC and thermal stability. OSM continues to increase due to their efficiency in removing pollutants from internal combustion engine exhausts, placing at the same time a strain on the supply of PGM and OSM including RE metals, which drives up their cost and the cost of catalysts applications.

There is therefore a need to manufacture Zero Platinum Group Metal (ZPGM) catalyst systems for TWC system which are free of PGM and RE metal and have high OSC property which may exhibit high thermal stability, high activity and enhanced conversion capabilities.

### SUMMARY

The present disclosure provides enhanced Zero Platinum Group Metals and Zero Rare Earth (ZPGM-ZRE) catalyst systems which may exhibit optimal OSC property, high thermal stability, and high catalyst activity.

According to an embodiment, disclosed ZPGM-ZRE catalyst system may include a ceramic substrate, a washcoat, and an overcoat.

According to an embodiment, washcoat may include pure alumina (Al₂O₃), and overcoat may include Cu—Mn spinel phase with Niobium-Zirconia support oxide, where the material may be dried and calcined at about 600° C. for about 5 hours to form spinel phase structure.

Disclosed ZPGM catalyst system is free of PGM and RE metals (ZPGM-ZRE) and may be prepared using suitable known in the art synthesis method. In order to prepare washcoat, co-milling process may be employed. Additionally, in order to prepare overcoat a co-precipitation method may be employed.

According to one aspect of the present disclosure, fresh and aged samples of disclosed ZPGM-ZRE catalyst system may be prepared in order to determine the effect of the thermal treatment temperature and gas flow conditions to show thermal stability of disclosed catalyst system.

Catalyst activity and thermal stability in a plurality of fresh and aged samples of disclosed ZPGM-ZRE catalyst system may be determined by performing rich to lean sweep tests under steady state and oscillating condition, and compared to results of sweep tests of commercial PGM catalyst systems that include Ce-based OSM.

The OSC property of fresh samples of disclosed ZPGM-ZRE catalyst system may be determined using CO and O₂ pulses under isothermal oscillating condition, referred in the present disclosure as OSC test, to determine O₂ and CO delay times, a parameter to show OSC property of disclosed catalyst system.

Disclosed ZPGM-ZRE catalyst system may be successfully employed in under floor catalyst systems because of its high OSC property and stability of activity at the temperature range applying in underfloor position.

Numerous other aspects, features and benefits of the present disclosure may be made apparent from the following detailed description taken together with the drawing figures.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 depicts ZPGM-ZRE catalyst system configuration, according to an embodiment.

FIG. 2 shows steady state sweep test results for samples of ZPGM-ZRE catalyst system and commercial PGM catalyst systems to determine NO conversion under rich condition to lean condition, according to an embodiment.

FIG. 3 shows steady test sweep test results for samples of fresh ZPGM-ZRE catalyst system to determine R-value at NO/CO cross over, according to an embodiment.

FIG. 4 shows steady state sweep test results for samples of ZPGM-ZRE catalyst system, hydrothermally aged at about 900° C., 4 hrs, to determine R-value at NO/CO cross over, according to an embodiment.

FIG. 5 shows steady state sweep test results for samples of ZPGM-ZRE catalyst system, hydrothermally aged at 800° C. for about 20 hrs, to determine R-value at NO/CO cross over, according to an embodiment.

FIG. 6 shows steady state sweep test results for samples of ZPGM-ZRE catalyst system, aged at 800° C., under commercial aging for underfloor condition, for about 20 hrs, to determine R-value at NO/CO cross over, according to an embodiment.

FIG. 7 shows OSC isothermal oscillating test results for samples of fresh PGM catalyst system, according to an embodiment.

FIG. 8 shows OSC isothermal oscillating test results for samples of fresh ZPGM-ZRE catalyst system, according to an embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### DEFINITIONS

As used here, the following terms may have the following definitions:

“Catalyst system” refers to a system of at least two layers including at least one substrate, a washcoat, and/or an overcoat.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat layer.

“Catalyst” refers to one or more materials that may be of use in the conversion of one or more other materials.

“Milling” refers to the operation of breaking a solid material into a desired grain or particle size.

“Co-precipitation” refers to the carrying down by a precipitate of substances normally soluble under the conditions employed.

“Calcination” refers to a thermal treatment process applied to solid materials, in presence of air, to bring about a thermal decomposition, phase transition, or removal of a volatile fraction at temperatures below the melting point of the solid materials.

“Adsorption” refers to the adhesion of atoms, ions, or molecules from a gas, liquid, or dissolved solid to a surface.

“Desorption” refers to the process whereby atoms, ions, or molecules from a gas, liquid, or dissolved solid are released from or through a surface.

“Zero platinum group (ZPGM) catalyst” refers to a catalyst completely or substantially free of platinum group metals.

“Platinum group metals (PGM)” refers to platinum, palladium, ruthenium, iridium, osmium, and rhodium.

“Oxygen storage material (OSM)” refers to a material able to take up oxygen from oxygen rich streams and able to release oxygen to oxygen deficient streams.

“Oxygen storage capacity (OSC)” refers to the ability of materials used as OSM in catalysts to store oxygen at lean condition and to release it at rich condition.

“Treating,” “treated,” or “treatment” refers to drying, firing, heating, evaporating, calcining, or mixtures thereof.

“Conversion” refers to the chemical alteration of at least one material into one or more other materials.

“R Value” refers to the number obtained by dividing the reducing potential by the oxidizing potential.

“Rare earth (RE) metals” refers to chemical elements in the lanthanides group, scandium, and yttrium.

“Zero rare earth metals (ZRE)” refers to metals not included in the rare earth metals.

“O₂ delay time” refers to the time required to reach to 50% of the O₂ concentration in feed signal.

“CO delay time” refers to the time required to reach to 50% of the CO concentration in feed signal.

### DESCRIPTION OF THE DRAWINGS

### Catalyst System Configuration

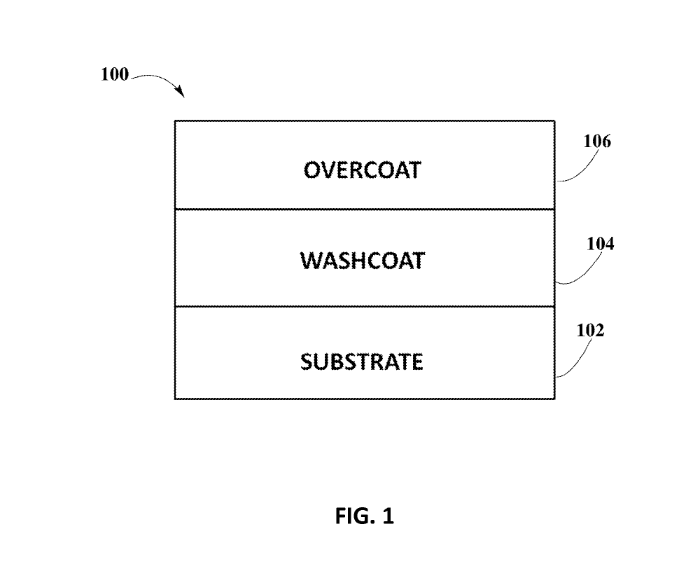

FIG. 1 depicts ZPGM-ZRE catalyst system 100 configuration of the present disclosure. As shown in FIG. 1, ZPGM-ZRE catalyst system 100 may include at least a substrate 102, a washcoat 104, and an overcoat 106, where washcoat 104 may include carrier material oxides, such as pure alumina and overcoat 106 may include a Cu—Mn spinel with Nb₂O₅—ZrO₂ as support oxide.

In an embodiment, substrate 102 materials may include a refractive material, a ceramic material, a honeycomb structure, a metallic material, a ceramic foam, a metallic foam, a reticulated foam, or suitable combinations, where substrate 102 may have a plurality of channels with suitable porosity. Porosity may vary according to the particular properties of substrate 102 materials. Additionally, the number of channels may vary depending upon substrate 102 used as is known in the art. The type and shape of a suitable substrate 102 would be apparent to one of ordinary skill in the art.

According to the present disclosure, preferred substrate material may be ceramic material.

Washcoat 104 may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof.

According to the present disclosure, most suitable material for disclosed washcoat 104 may be pure alumina (Al₂O₃).

According to an embodiment, overcoat 106 may include a Cu—Mn stoichiometric spinel, Cu_{1.0}Mn_{2.0}O₄, as ZPGM-ZRE transition metal catalyst. Additionally, overcoat 106 may include support oxide, such as Nb₂O₅—ZrO₂.

Preparation of ZPGM-ZRE Catalyst Systems

A ZPGM-ZRE catalyst system 100 including a ceramic substrate 102, a washcoat 104, and an overcoat 106 may be prepared.

In order to prepare washcoat 104, co-milling process may be employed. Co-milling process may begin with mixing alumina with water or any suitable organic solvent. Suitable organic solvents may include ethanol, diethyl ether, carbon tetrachloride, trichloroethylene, among others. Milling process in which washcoat 104 materials may be broken down into smaller particle sizes, may take about 10 minutes to about 10 hours, depending on the batch size, kind of material and particle size desired. The milling process may be achieved by employing any suitable mill such as vertical or horizontal mills. In order to measure exact particle size desired during the milling process, a laser light diffraction equipment may be employed. After milling process, a catalyst aqueous washcoat 104 slurry may be obtained. In order to enhance binding property washcoat 104 to substrate 102, aqueous washcoat 104 slurry obtained in milling process may undergo adjusting rheology, in which, acid or base solutions or various salts or organic compounds may be added to the aqueous washcoat 104 slurry. Some examples of compounds that can be used to adjust the rheology may include ammonium hydroxide, aluminum hydroxide, acetic acid, citric acid, tetraethyl ammonium hydroxide, other tetralkyl ammonium salts, ammonium acetate, and ammonium citrate, among others. The milled carrier material oxide may be deposited on substrate 102 in the form of washcoat 104 and then thermally treated. Washcoat 104 may be thermally treated or fired for about 4 hours at a temperature of about of 550° C. to about 700° C., preferably 550° C. Various capacities of washcoat 104 loadings may be coated on the ceramic substrate 102. Washcoat 104 loading may vary from 60 g/L to 200 g/L, most suitable washcoat 104 loading may be 120 g/L.

The preparation of overcoat 106 may begin by milling Nb₂O₅—ZrO₂ support oxide to make aqueous slurry. The Nb₂O₅—ZrO₂ support oxide may have Nb₂O₅ loadings of about 15% by weight to about 30% by weight, preferably about 25% and ZrO₂ loadings of about 70% by weight to about 85% by weight, preferably about 75% by weight.

The Cu—Mn solution may be prepared by mixing an appropriate amount of Mn nitrate solution (MnNO₃) and Cu nitrate solution (CuNO₃), where the suitable copper loadings may include loadings in a range of about 10% by weight to about 15% by weight. Suitable manganese loadings may include loadings in a range of about 15% by weight to about 25% by weight. The next step is precipitation of Cu—Mn nitrate solution on Nb₂O₅—ZrO₂ support oxide aqueous slurry, which may have a suitable base solution added thereto, such as to adjust the pH of the slurry to a suitable range. The precipitated Cu—Mn/Nb₂O₅—ZrO₂ slurry may be aged for a period of time of about 12 to 24 hours under continued stirring at room temperature.

For preparation of overcoat 106, after precipitation step, the Cu—Mn/Nb₂O₅—ZrO₂ slurry may be coated on washcoat 104 in order to form overcoat 106 employing suitable coating techniques as known in the art, such as vacuum dosing, among others. Overcoat 106 loading may vary from about 60 g/L to about 200 g/L, in this disclosure particularly about 120 g/L.

According to embodiments in the present disclosure, treatment of overcoat 106 may be achieved employing suitable drying and heating processes. A commercially-available air knife drying system may be employed for drying overcoat 106. Heat treatments may be performed using commercially-available firing (calcination) systems. The thermal treatment may take from about 2 hours to about 6 hours, preferably about 5 hours, at a temperature within a range of about 550° C. to about 650° C., preferably at about 600° C.

According to principles of the present disclosure, a suitable overcoat 106 may have a chemical composition with a total loading of about 120 g/L, including a Cu—Mn spinel with copper loading of about 10 g/L to about 15 g/L and manganese loading of about 20 g/L to about 25 g/L. The Nb₂O₅—ZrO₂ support oxide may have loadings of about 80 g/L to about 90 g/L.

Catalyst activity of disclosed ZPGM-ZRE catalyst system 100 may be determined and compared with catalyst activity of commercial PGM catalyst system 100, such as a fresh PGM catalyst system 100 that includes a palladium (Pd) catalyst and rhodium (Rh) catalyst including 6 g/ft³ Pd, 6 g/ft³ Rh, and OSM, using loading of about 60% by weight. The OSM may include several RE metals, mostly CeO₂, with loading of about 30% by weight to about 40% by weight.

Isothermal Steady State Sweep Test Procedure

According to an embodiment, the isothermal steady state sweep test was performed employing a test reactor at temperature of about 450° C. Steady state sweep test covered 11 points from rich condition (R-value=2.0) to lean condition (R-value=0.80). Steady state sweep test was conducted at a space velocity (SV) of 40,000 h⁻¹.

The simulated exhaust was a standard TWC gas composition that may include 8,000 ppm of CO, 400 ppm of C₃H₆, 100 ppm of C₃H₈, 1000 ppm of NO_{R}, 2000 ppm of H₂, 10% of CO₂, 10% of H₂O, and a quantity of O₂ that may be oscillated to represent the three-way condition of the control loop in an exhaust system, where the air-fuel ratio (A/F) oscillates between rich conditions and lean conditions.

Steady state sweep test results show the CO, HC, and NOx breakthrough measured at about 450° C., in percentage, in the “y” axis and the values for each embodiment at different R values in the “x” axis. R values may be a value defined as the product of dividing the reducing potential by the oxidizing potential. When R equals 1.0, it may be considered as a stoichiometric condition, values greater than 1.0 considered as rich condition and values lower than 1.0 may be considered as lean condition.

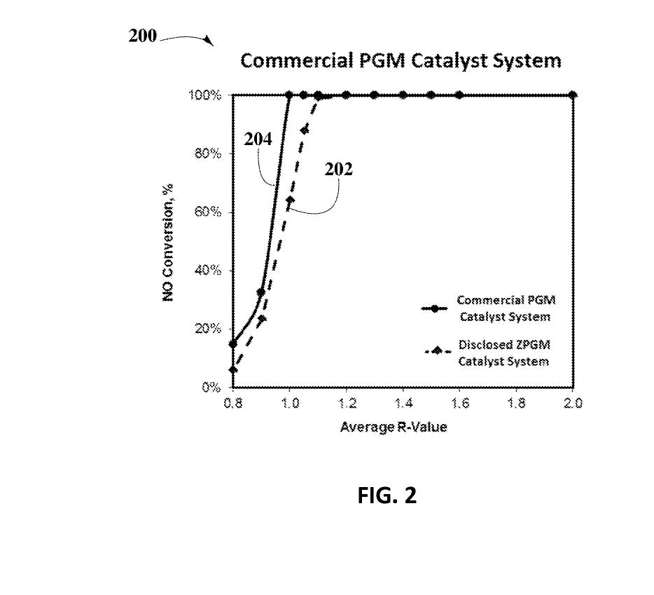

FIG. 2 shows sweep test results for NO conversion 200, where disclosed ZPGM-ZRE catalyst system 100 is tested in comparison with commercial PGM catalyst system 100. Both catalyst systems are fresh. Commercial PGM catalyst system 100 include palladium (Pd) and rhodium (Rh) as PGM; as well as rare earth (RE) metal, mostly CeO₂, with loading of about 30% by weight to about 40% by weight. Amount of palladium may be of about 6 g/ft³ and amount of rhodium may be of about 6 g/ft³.

In FIG. 2, ZPGM-ZRE NO conversion curve 202, and PGM NO conversion curve 204 may be observed. As shown in FIG. 2, at R value of about 1.05 which is very close to stoichiometry, disclosed ZPGM-ZRE catalyst system 100 exhibits NO conversion of about 88%. Moreover at the same R value, NO conversion for commercial PGM catalyst system 100 is about 100%. Thus disclosed ZPGM-ZRE catalyst system 100 shows high catalyst activity which is close to PGM catalyst system 100 performance. Furthermore, at R value of about 1.1 and above, NO conversion of disclosed ZPGM-ZRE catalyst system 100 is about 100%.

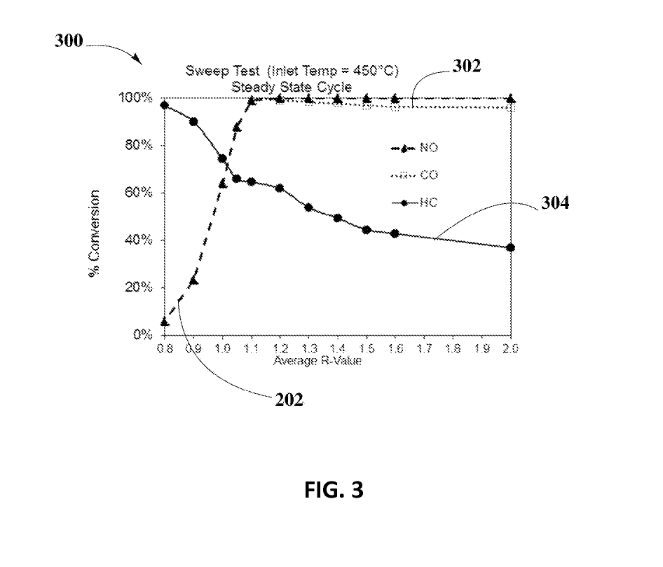

FIG. 3 shows steady state sweep test results 300 for disclosed ZPGM-ZRE catalyst system 100 where fresh sample of ZPGM-ZRE catalyst system 100 was tested in order to determine R-value at NO/CO cross over. As may be seen in FIG. 3, NO conversion curve 202, CO conversion curve 302, and conversion HC curve 304, shows that the NO/CO cross over takes place at the specific R-value of about 1.158, thus, demonstrating that NO and CO conversion at R value of about 1.158 is about 100%. Additionally, NO/HC cross over is at R-value of about 1.02 and NO and HC conversion is about 71%.

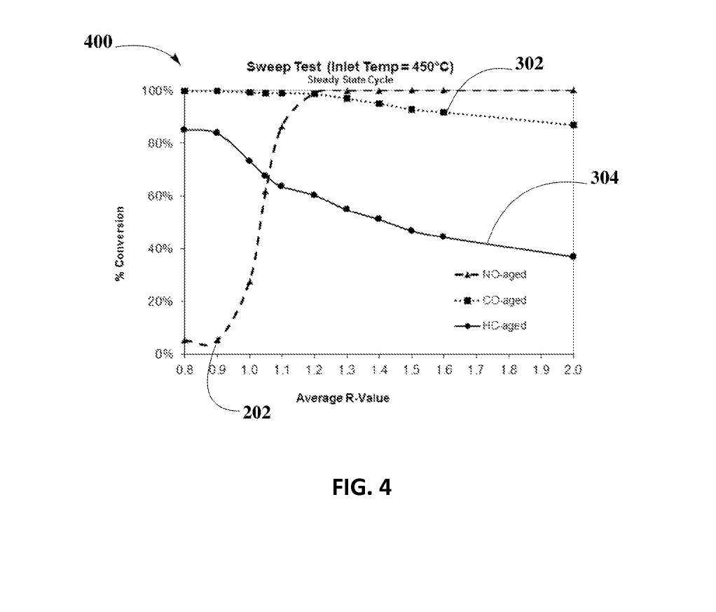

FIG. 4 shows steady state sweep test results 400 for disclosed ZPGM-ZRE catalyst system 100, where samples of ZPGM-ZRE catalyst system 100 were hydrothermally (10% steam) aged at 900° C. for about 4 hrs, and tested in order to determine R-value at NO/CO cross over. In FIG. 4, ZPGM-ZRE NO conversion curve 202, ZPGM-ZRE CO conversion curve 302, and ZPGM-ZRE conversion HC curve 304 may be observed. As shown in FIG. 4, NO/CO cross over takes place at the specific R-value of about 1.198, thus NO and CO conversion at R value of about 1.198 is 99%. Also, NO/HC cross over is at R-value of about 1.06 and NO and HC conversion is about 67%. Steady state sweep test results 400 for disclosed ZPGM-ZRE catalyst system 100 show that catalyst activity of ZPGM-ZRE catalyst system 100, slightly decreases (from an R value of about 1.158 to an R value of about 1.198) when ZPGM catalyst system 100 is aged at 900° C. for about 4 hrs.

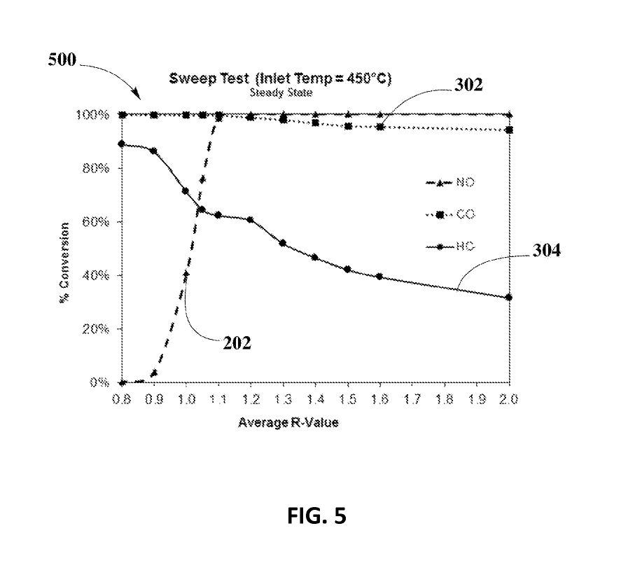

FIG. 5 shows steady state sweep test results 500 for disclosed ZPGM-ZRE catalyst system 100, where samples of ZPGM-ZRE catalyst system 100 were hydrothermally (10% steam) aged at 800° C. for about 20 hrs, and tested in order to determine R-value at NO/CO cross over. In FIG. 5, ZPGM-ZRE NO conversion curve 202, ZPGM-ZRE CO conversion curve 302, and ZPGM-ZRE conversion HC curve 304 may be observed. As shown in FIG. 5, NO/CO cross over takes place at the specific R-value of about 1.1, thus NO and CO conversion at an R value of about 1.1 is about 100%. Also, NO/HC cross over is at an R-value of about 1.04 and NO and HC conversion is about 65%. These results demonstrate that ZPGM-ZRE catalyst system 100 has thermal stability after aging at 800° C. Additionally, steady state sweep test results 600 for disclosed ZPGM-ZRE catalyst system 100 show that catalyst activity of ZPGM-ZRE catalyst system 100 slightly increases when ZPGM-ZRE catalyst system 100 is hydrothermally aged at 800° C. for about 20 hrs compared to ZPGM-ZRE catalyst system 100 is hydrothermally aged at 900° C. for about 4 hrs.

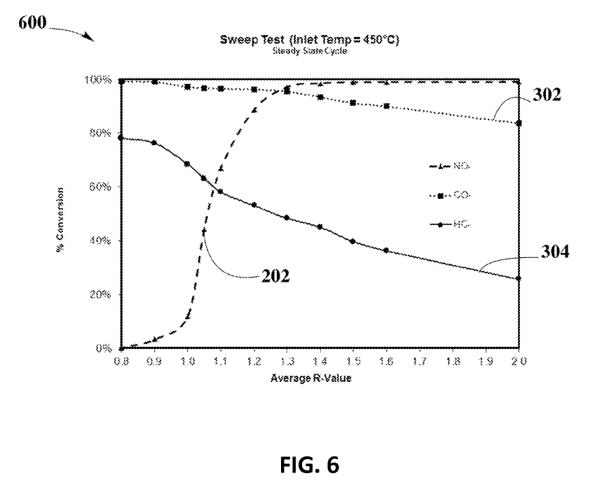

FIG. 6 shows steady state sweep test results 600 for disclosed ZPGM-ZRE catalyst system 100, where samples of ZPGM-ZRE catalyst system 100 were aged at 800° C., under commercial aging for underfloor condition, for about 20 hrs, and tested in order to determine R-value at NO/CO cross over. Commercial aging of the ZPGM-ZRE catalyst system 100 may be performed at a temperature of about 800° C. for about 20 hours, with fuel gas including CO, O₂, CO₂, H₂O and N₂ as aging fuel feed running at moderate or high power to test the thermal and chemical stability of the ZPGM-ZRE metals OSM within ZPGM-ZRE catalyst system 100. In FIG. 6, ZPGM-ZRE NO conversion curve 202, ZPGM-ZRE CO conversion curve 302, and ZPGM-ZRE conversion HC curve 304 may be observed. As shown in FIG. 6, NO/CO cross over takes place at the specific R-value of about 1.26, thus NO and CO conversion at an R value of about 1.25 is about 96%. Also, NO/HC cross over is at an R-value of about 1.08 and NO and HC conversion is about 60%. These results demonstrate that ZPGM-ZRE catalyst system 100 has good catalyst activity after commercial underfloor aging. Additionally, steady state sweep test results 600 for ZPGM-ZRE catalyst system 100 show that this ZPGM-ZRE catalyst system 100 has good thermal stability when ZPGM-ZRE catalyst system 100 is aged at 800° C., under commercial aging for underfloor condition, for about 20 hrs.

Steady state sweep test results 300, steady state sweep test results 400, steady state sweep test results 500, and steady state sweep test results 600 show that fresh and aged samples of disclosed ZPGM-ZRE catalyst system 100, that includes a Cu—Mn stoichiometric spinel structure, as ZPGM-ZRE with Nb₂O₅—ZrO₂ support oxide, with no OSM, may exhibit great activity comparable to commercial PGM catalyst system 100 that includes palladium and rhodium as PGM and conventional Ce-based OSM. Additionally, steady state sweep test results 600 show that stability of spinal catalyst included in disclosed ZPGM-ZRE catalyst system 100 may be affected slightly by high thermal treatment temperatures, such as commercial aging for underfloor conditions.

In another aspect of the present disclosure, ZPGM-ZRE catalyst system 100 may be subjected to testing under OSC isothermal oscillating condition to determine OSC property of disclosed ZPGM-ZRE catalyst system 100. Therefore, ZPGM-ZRE catalyst system 100 that includes a Cu—Mn stoichiometric spinel structure supported on Nb₂O₅—ZrO₂, may be compared under isothermal oscillating condition with commercial PGM catalyst system 100 that includes palladium and conventional Ce-based OSM. The results of O₂ and CO delay time show improved oxygen storage property of disclosed ZPGM-ZRE catalyst system 100.

Isothermal OSC Test Procedure

Testing of the OSC property of disclosed ZPGM-ZRE catalyst system 100 as well as OSC property of commercial PGM catalyst system 100 may be performed under isothermal oscillating condition to determine O₂ and CO delay times.

The OSC isothermal test may be carried out at temperature of about 575° C. with a feed of either O₂ with a concentration of about 4,000 ppm diluted in inert nitrogen (N₂), or CO with a concentration of about 8,000 ppm of CO diluted in inert N₂. The OSC isothermal oscillating test may be performed in a quartz reactor using a space velocity (SV) of 60,000 hr-1, ramping from room temperature to isothermal temperature of about 575° C. under dry N₂. At the temperature of about 575° C., OSC test may be initiated by flowing O₂ through the hydrothermally aged OSM sample in the reactor, and after 2 minutes, the feed flow may be switched to CO to flow, separately, through the disclosed ZPGM-ZRE catalyst system 100 sample in the reactor for another 2 minutes, enabling the isothermal oscillating condition between CO and O₂ flow during a total time of about 1,000 seconds. Additionally, O₂ and CO may be allowed to flow in the empty test reactor not including catalyst sample. Subsequently, testing may be performed allowing O₂ and CO to flow in the test tube reactor including ZPGM-ZRE catalyst system 100 or commercial PGM catalyst system 100 sample and determine the OSC property. As disclosed ZPGM-ZRE catalyst system 100 may have OSC property, ZPGM-ZRE catalyst system 100 may store O₂ when O₂ flows. Subsequently, when CO may be allowed to flow, there is no O₂ flowing, and the O₂ stored in OSM within ZPGM-ZRE catalyst system 100 may react with the CO to form CO₂. The time during which ZPGM-ZRE catalyst system 100 may store O₂ and the time during which CO may be oxidized to form CO₂ may be measured.

OSC Property of Commercial PGM Catalyst System

The fresh sample of PGM catalyst system 100 may be a palladium (Pd) catalyst including 20 g/ft³ Pd and OSM, using loading of about 60% by weight. The OSM may include several RE metals, mostly CeO₂, with loading of about 30% to about 40% by weight.

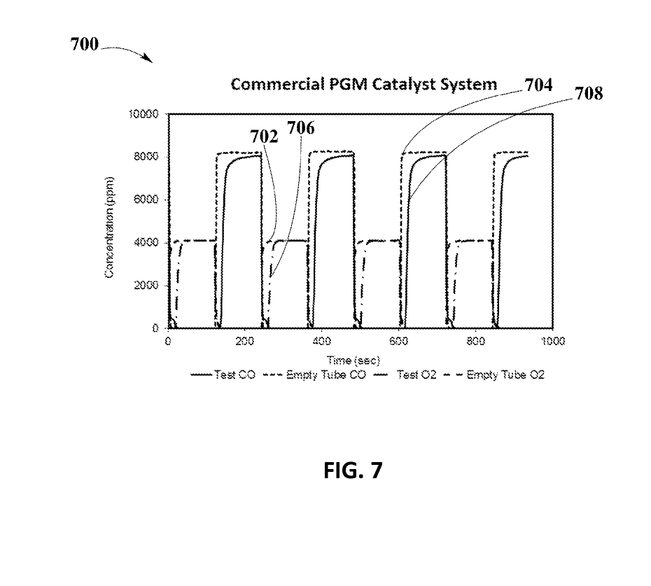

FIG. 7 shows OSC isothermal oscillating test results 700 for fresh commercial PGM catalyst system 100, at temperature of about 575° C., according to an embodiment. In FIG. 7, curve 702 shows the result of flowing 4,000 ppm O₂ through an empty test reactor which may be used for OSC isothermal oscillating test; curve 704 depicts the result of flowing 8,000 ppm CO through the empty test reactor; curve 706 shows the result of flowing 4,000 ppm O₂ through the test reactor including commercial PGM catalyst system 100; and curve 708 depicts the result of flowing 8,000 ppm CO through the test reactor including the commercial PGM catalyst system 100.

It may be observed in FIG. 7, OSC isothermal oscillating test results 700 for fresh commercial PGM catalyst system 100, where O₂ signal in presence of fresh commercial PGM catalyst system 100, as shown in curve 706, does not reach the O₂ signal of empty reactor shown in curve 702. This result indicates the storage of a large amount of O₂ in the fresh commercial PGM catalyst system 100 sample. The measured O₂ delay time, which is the time required to reach to an O₂ concentration of 2,000 ppm (50% of feed signal) in presence of the fresh commercial PGM catalyst system 100, is about 20.03 seconds.

Similar result may be observed for CO. As may be seen in FIG. 7, CO signal in presence of OSM within fresh commercial PGM catalyst system 100 shown in curve 706 does not reach the CO signal of empty reactor shown in curve 702. This result indicates the consumption of a significant amount of CO by OSM within fresh commercial PGM catalyst system 100 and desorption of stored O₂ for the conversion of CO to CO₂. The measured CO delay time, which is the time required to reach to a CO concentration of 4000 ppm in the presence of OSM within commercial PGM catalyst system 100 sample is about 17.56 seconds.

OSC Property of ZPGM-ZRE Catalyst System

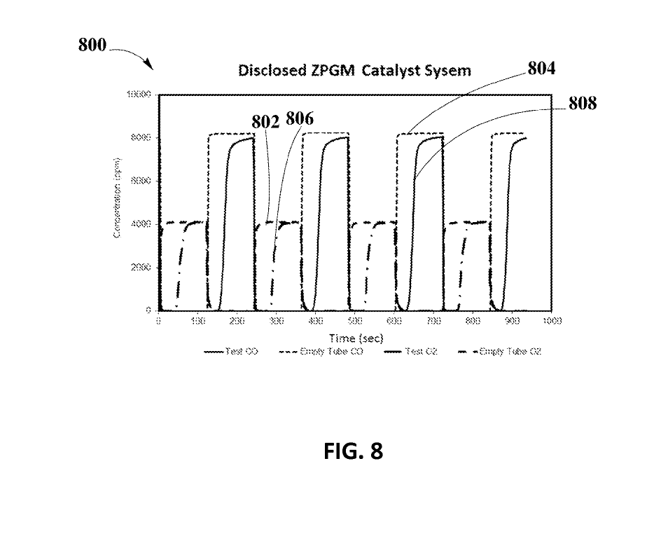

FIG. 8 shows OSC isothermal oscillating test results 800 for fresh ZPGM-ZRE catalyst system 100, at temperature of about 575° C., according to an embodiment. In FIG. 8, curve 802 shows the result of flowing 4,000 ppm O₂ through an empty test reactor which may be used for OSC isothermal oscillating test; curve 804 depicts the result of flowing 8,000 ppm CO through the empty test reactor; curve 806 shows the result of flowing 4,000 ppm O₂ through the test reactor including ZPGM-ZRE catalyst system 100; and curve 808 depicts the result of flowing 8,000 ppm CO through the test reactor including the disclosed ZPGM-ZRE catalyst system 100.

It may be observed in FIG. 8 that the O₂ signal in presence of the disclosed ZPGM-ZRE catalyst system 100, as shown in curve 806, does not reach the O₂ signal of empty reactor shown in curve 802. This result indicates the storage of a large amount of O₂ in the disclosed ZPGM-ZRE catalyst system 100. The measured O₂ delay time, which is the time required to reach to an O₂ concentration of 2,000 ppm (50% of feed signal) in presence of the OSM within ZPGM-ZRE catalyst system 100 sample, is about 45.75 seconds. The O₂ delay time measured from OSC isothermal oscillating test indicates that the disclosed ZPGM-ZRE catalyst system 100 has a significant OSC property, and that OSC property of ZPGM-ZRE catalyst system 100 exhibits a higher OSC property compared to fresh commercial PGM catalyst system 100 analyzed in FIG. 7.

Similar result may be observed for CO. As may be seen, the CO signal in presence of disclosed ZPGM-ZRE catalyst system 100 shown in curve 808 does not reach the CO signal of empty reactor shown in curve 804. This result indicates the consumption of a significant amount of CO by the disclosed ZPGM-ZRE catalyst system 100 and desorption of stored O₂ for the conversion of CO to CO₂. The measured CO delay time, which is the time required to reach to a CO concentration of 4000 ppm in the presence of OSM within ZPGM-ZRE catalyst system 100 is about 42.28 seconds. The CO delay time measured from OSC isothermal oscillating test shows that the disclosed ZPGM-ZRE catalyst system 100 has a significant OSC property.

The measured O₂ delay time and CO delay times may be an indication that the disclosed ZPGM-ZRE catalyst system 100, substantially free from PGM and without the presence of RE metals, may exhibit enhanced OSC, and thus, catalyst activity, as noted by the highly activated total and reversible oxygen adsorption and CO conversion that occurs under oscillating condition.

In other embodiments, OSC isothermal oscillating test may be performed on aged samples of ZPGM-ZRE catalyst system 100, which may be performed in the test reactor using SV of 60,000 hr⁻¹, ramping from room temperature to isothermal temperature of about 575° C. under dry N₂. Repeated switching from flowing O₂ and flowing CO may be enabled about every 2 minutes for a total time of about 1,000 seconds. The aged sample of ZPGM-ZRE catalyst system 100 in the present embodiment may be hydrothermally aged employing 10% steam/air at about 800° C. for about 20 hours.

The measured O₂ delay time and CO delay time for the aged sample of ZPGM-ZRE catalyst system 100 is about 32.7 seconds and 30.59 seconds, respectively. The O₂ delay time measured from OSC isothermal oscillating test indicates that the aged sample of ZPGM-ZRE catalyst system 100 has a significant OSC property in which hydrothermal aging condition at about 800° C. for about 20 hours may be a very important parameter to consider for the obtained high activity.

The measured O₂ delay time and CO delay times may be an indication that the aged sample of ZPGM-ZRE catalyst system 100 may exhibit enhanced OSC as noted by the highly activated total and reversible oxygen adsorption and CO conversion that occurs under isothermal oscillating condition compared to commercial PGM catalyst that includes OSM.

The ZPGM-ZRE catalyst system 100 under commercial aging condition may provide optimal catalytic performance for underfloor catalyst applications, which may be confirmed the very high OSC property that results after OSC isothermal oscillating test. The OSC property of the sample of ZPGM-ZRE catalyst system 100, even after aging, is higher than commercial PGM catalyst system 100 used for underfloor applications under real use condition.

Steady state sweep test results and OSC isothermal oscillating test results for ZPGM-ZRE catalyst system 100 show that catalyst system 100 free of PGM and RE metal is active, is stable at higher temperature and has high OSC property, without needing the addition of OSM to enhance activity. Therefore, these results show that disclosed ZPGM-ZRE catalyst system 100 may be manufactured at a low cost, because there is no need to include OSM in ZPGM-ZRE catalyst system 100 to make it more active.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalyst system, comprising:
a substrate;
a washcoat;
an overcoat comprising at least one oxygen storage material is substantially free of platinum group metals and rare earth metals; and
wherein the at least one oxygen storage material comprises Cu—Mn spinel having a niobium-zirconia support oxide; and
wherein the washcoat comprises Al₂O₃.

2. The catalyst system of claim 1, wherein the Cu—Mn spinel comprises CuMn₂O₄.

3. The catalyst system of claim 1, wherein the niobium-zirconia support oxide comprises Nb₂O₅—ZrO₂.

4. The catalyst system of claim 1, wherein the at least one oxygen storage material is calcined at about 600° C.

5. The catalyst system of claim 1, wherein the calcination is for about 5 hours.

6. The catalyst system of claim 1, wherein the niobium-zirconia support oxide comprises about 15% to about 30% by weight of Nb₂O₅.

7. The catalyst system of claim 1, wherein the niobium-zirconia support oxide comprises about 25% by weight of Nb₂O₅.

8. The catalyst system of claim 1, wherein the niobium-zirconia support oxide comprises about 70% to about 85% by weight of ZrO₂.

9. The catalyst system of claim 1, wherein the niobium-zirconia support oxide comprises about 75% by weight of ZrO₂.

10. The catalyst system of claim 1, wherein the at least one oxygen storage material is deposited on the substrate at about 120 g/L.

11. The catalyst system of claim 1, wherein the Cu—Mn spinel comprises about 10 g/L to about 15 g/L of Cu.

12. The catalyst system of claim 2, wherein the Cu—Mn structure comprises about 20 g/L to about 25 g/L of Mn.

13. The catalyst system of claim 1, wherein the niobium-zirconia support oxide is deposited on the substrate at about 80 g/L to about 90 g/L.

14. The catalyst system of claim 1, wherein the at least one oxygen storage material is at least partially aged.

15. The catalyst system of claim 1, wherein the at least one oxygen storage material is applied to the substrate by co-precipitation.

16. The catalyst system of claim 1, wherein the at least one oxygen storage material stores O₂ at a concentration of about 8,000 ppm.

17. The catalyst system of claim 1, wherein the at least one oxygen storage material stores CO at a concentration of about 8,000 ppm.

18. The catalyst system of claim 1, wherein the R value is about 1.05.

19. The catalyst system of claim 18, wherein the conversion of NO is about 88%.

20. The catalyst system of claim 1, wherein the R value is about 1.1.

21. The catalyst system of claim 20, wherein the conversion of NO is about 100%.

22. The catalyst system of claim 1, wherein the R value is about 1.158.

23. The catalyst system of claim 1, wherein the R value is about 1.04.

21. The catalyst system of claim 23, wherein the conversion of NO and HC is about 65%.
